(19) United States
(12) Patent Application Publication
(10) Pub. No.: US 2012/0069699 A1
(43) Pub. Date: Mar. 22, 2012

(54) HORIZONTAL DOUGH MIXER ASSEMBLY WITH MULTI-REDUCTION GEAR ARRANGEMENT FOR BOWL TILT

(76) Inventors: Gregory A. Balnoschan, Powell, OH (US); Douglas A. Gaier, Piqua, OH (US); Randy L. Jacoby, Sidney, OH (US); Ankush B. Mittal, Bowling Green, OH (US)

(21) Appl. No.: 13/231,563

(22) Filed: Sep. 13, 2011

Related U.S. Application Data
(60) Provisional application No. 61/382,340, filed on Sep. 13, 2010.

(51) Int. Cl. B01F 9/08; B01F 15/02

(52) U.S. Cl. 366/185; 366/218

(57) ABSTRACT

A mixing bowl-tilt system for a horizontal mixer includes a multi-stage gear reduction unit having an input and an output, wherein the input is connected to be rotated by a motor and the output is operatively connected to rotate a mixing bowl. Rotation of the input results in rotation of the mixing bowl. The multi-stage gear reduction unit is non-back driving and self locking and includes a first stage reduction and a second stage reduction.

### CROSS-REFERENCES

This application claims the benefit of provisional application Ser. No. 61/382,340, filed Sep. 13, 2010, the entirety of which is incorporated herein by reference.

### TECHNICAL FIELD

This application relates generally to horizontal dough mixers and more particularly to a multi-reduction gear arrangement for tilting a mixing bowl of a horizontal dough mixer.

### BACKGROUND

Commercial horizontal dough mixers are provided for mixing large amounts of dough at one time. As use herein the term mixer is intended to refer to horizontal mixers. In some instances, it may be desirable to mix, for example, between about 400 and 3,200 pounds of dough. An agitator is often used in mixing the dough. The agitator is driven by a drive shaft operatively linked to a motor. In order to remove the dough from the bowl the bowl is typically tilted while running the agitator at a slow speed (commonly referred to as “jog and tilt”) such that the agitator tends to push the dough out of the bowl.

In the past, hydraulic arrangements have been used for bowl tilting due to their ability to handle the high torque stresses encountered during bowl tilt. The hydraulics design requires large number of hours and parts for installation and consumes space. It would be desirable to provide a bowl tilting arrangement that eliminates such hydraulics but still has the capability to handle the high torque stresses.

### SUMMARY

In an aspect, a horizontal mixer arrangement includes a mixer bowl, an agitator within the mixer bowl and a shaft extending through a wall of the mixer bowl for moving the agitator. A bowl tilt mechanism using a direct drive multi-stage gear reduction unit is provided.

In yet another aspect, a mixer bowl tilt mechanism using a gearbox with direct drive to a tilt bearing head is provided.

In yet another aspect, a multi-stage reduction gearbox is configured as a completely sealed unit having a compact design, which can be added on to existing mixing machines.

In a further aspect, a mixer bowl tilt mechanism using a gearbox and having built-in non-back driving and self locking gear design is provided.

In one aspect, a horizontal mixer includes a mixer bowl, an agitator within the mixer bowl and an agitator shaft for moving the agitator, where the agitator shaft extends through a wall of the mixer bowl. At least one support is connected to support the mixer bowl and pivot the mixer bowl. A bearing assembly includes a first portion that is rigidly connected for movement with the support and a second portion that rotatably supports the agitator shaft. A bowl-tilt mechanism includes a multi-stage gear reduction unit having an input and an output, where the output is operatively connected to the first portion of the bearing assembly such that rotation of the output effects rotation of the first portion of the bearing assembly to rotate the support and thus the mixing bowl.

In the mixer of the immediately preceding paragraph, the input of the multi-stage gear reduction unit may be a shaft that is directly rotated by a motor.

In the mixer of either of the two immediately preceding paragraphs the multi-stage gear reduction unit may be rigidly mounted to inhibit rotation of the multi-stage gear reduction unit.

In the mixer of any of the three immediately preceding paragraphs the multi-stage gear reduction unit may be mounted to a plate and a torque arm may have one end connected to the plate and an opposite end connected to a frame of the mixer.

In the mixer of any of the four immediately preceding paragraphs the multi-stage gear reduction unit may be non-back driving and self locking.

In the mixer of any of the five immediately preceding paragraphs the multi-stage gear reduction unit may have an associated motor to provide a self-contained unit.

In the mixer of any of the six immediately preceding paragraphs the multi-stage gear reduction unit may include an oil (or other gear lubricant) fill level port that is located above a level of both a first stage reduction and a second stage reduction of the unit.

In the mixer of any of the seven immediately preceding paragraphs the input may be associated with the first stage reduction and act as a primary input that is driven by the motor, and the multi-stage gear reduction unit may further include a secondary input for enabling operation of the unit via a hand tool or power tool.

In the mixer of the immediately preceding paragraph the primary input may be associated with a first end of a primary shaft of the first stage reduction and the secondary input may be associated with a second end of the primary shaft.

In the mixer of any of the nine immediately preceding paragraphs the multi-stage gear reduction unit may include a first stage reduction and a second stage reduction, wherein power from the first stage reduction is transmitted at a right angle to the second stage reduction.

In the mixer of any of the ten immediately preceding paragraphs the first reduction stage reduction and the second reduction stage reduction may be in a skew-axis gearing arrangement.

In the mixer of any of the eleven immediately preceding paragraphs the multi-stage gear reduction unit may include a first stage reduction and a second stage reduction, the first stage reduction between about 35 to 1 and about 45 to 1, and the second stage reduction between about 15 to 1 and about 30 to 1, resulting in an overall reduction of between about 525 to 1 and about 1350 to 1.

In the mixer of the immediately preceding paragraph the overall reduction may be between about 800 to 1 and about 950 to 1.

In the mixer of any of the thirteen immediately preceding paragraphs the bowl-tilt mechanism may further include a rotation limit plate that interacts with stops to provide rotational position limits of the mixing bowl.

In the mixer of any of the fourteen immediately preceding paragraphs the rotation of the mixer bowl may be limited to about one-hundred twenty degrees.

In another aspect, a mixing bowl-tilt system for a horizontal mixer includes a multi-stage gear reduction unit having an input and an output, wherein the input is connected to be rotated by a motor and the output is operatively connected to rotate a mixing bowl. Rotation of the input results in rotation of the mixing bowl. The multi-stage gear reduction unit is non-back driving and self locking and includes a first stage reduction and a second stage reduction.

In the system of the immediately preceding paragraph, the first stage reduction may be between about 35 to 1 and about 45 to 1, and the second stage reduction between about 15 to 1 and about 30 to 1, resulting in an overall reduction of between about 525 to 1 and about 1350 to 1.

In the system of either of the two immediately preceding paragraphs, the input may be associated with the first stage reduction and act as a primary input that is driven by the motor, and the multi-stage gear reduction unit may further include a secondary input for enabling operation of the unit via a hand tool or power tool, the primary input associated with a first end of a primary shaft of the first stage reduction and the secondary input associated with a second end of the primary shaft.

The details of one or more embodiments are set forth in the accompanying drawings and the description below. Other features, objects, and advantages will be apparent from the description and drawings.

### BRIEF DESCRIPTION OF THE DRAWINGS

FIG. 1 is a front view of an embodiment of a mixer;

FIG. 2 is an enlarged perspective view of a portion of the mixer of FIG. 1 showing a bowl tilt arrangement;

FIG. 3 is perspective view of the mixer of FIG. 1 showing the full multi-reduction gearbox unit;

FIG. 4 is partial perspective showing the tilt arrangement;

FIG. 5 is a partial front elevation of the tilt arrangement;

FIG. 6 shows a multi-reduction gearbox unit alone;

FIG. 7 shows internal components of the unit of FIG. 6; and

FIG. 8 shows a partial perspective of the tilt arrangement with gearbox housings and gearing removed.

### DETAILED DESCRIPTION

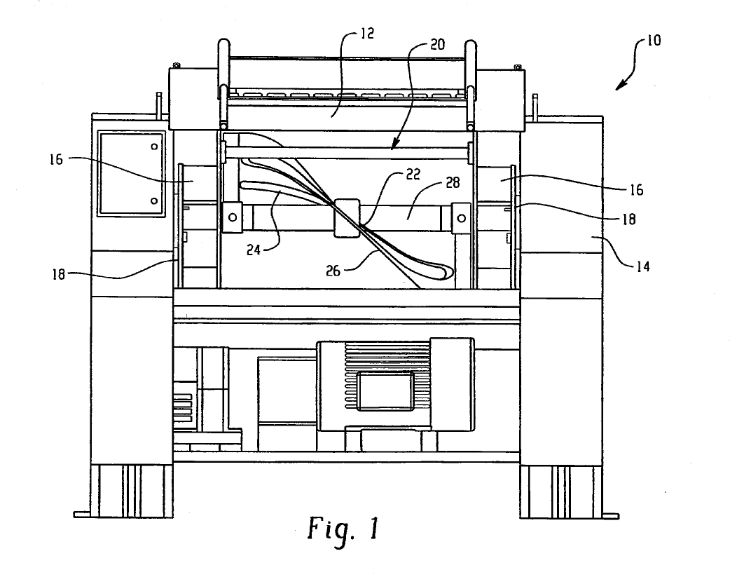

Referring to FIG. 1, a dough mixer 10 includes a mixing bowl 12 mounted within a cabinet 14. The mixing bowl 12 is an open top 20 arrangement that, in this illustration, is rotated to a sideways position. The mixing bowl 12 is supported at each end by support members 16 that are mounted to a support plate 18. An agitator 22 is rotatably mounted within the mixing bowl 12. The agitator 22 includes a pair of mixing arms 24 and 26 and a horizontally extending rotatable shaft 28 that supports and rotates the mixing arms 24 and 26 during a mixing operation. While agitator 22 is shown by FIG. 1, various agitator assemblies can be utilized including refrigerated agitator assemblies. The support plates 18 are mounted to part of a cabinet frame in a manner that enables the support plates to rotate, facilitating a tilting operation of the bowl as shown in FIG. 1. In the embodiments described below, one of the support plates 18 is linked to the described multi-reduction gear arrangement to implement the bowl tilt.

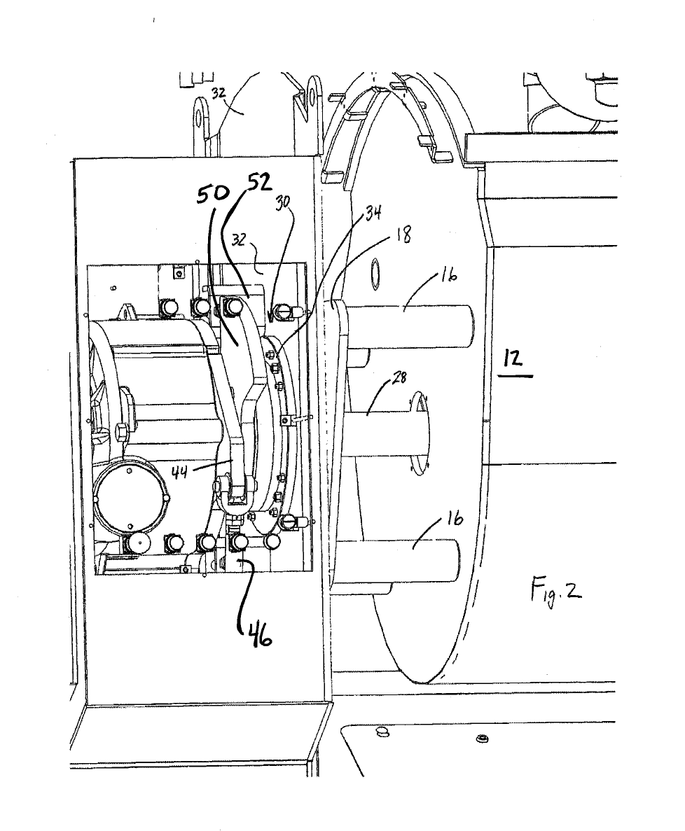

Referring to FIG. 2, the support plate 18 is connected to a bearing arrangement 30 that is supported by a cabinet frame panel 32 by a flange connection 34, where the bearing arrangement 30 is on the opposite side of the frame panel 32 from the support plate 18. The bearing arrangement 30 is configured to receive and permit rotation of an end of the agitator shaft 28 that extends from the side of the mixing bowl 12. A seal arrangement (not shown) may be located around the shaft adjacent the side of the bowl. The bearing arrangement 30 is configured such that the shaft 28 can rotate freely relative to the support plate 18, and so that the support plate 18 can be rotated in a controlled manner via rotation of part of the bearing arrangement 30.

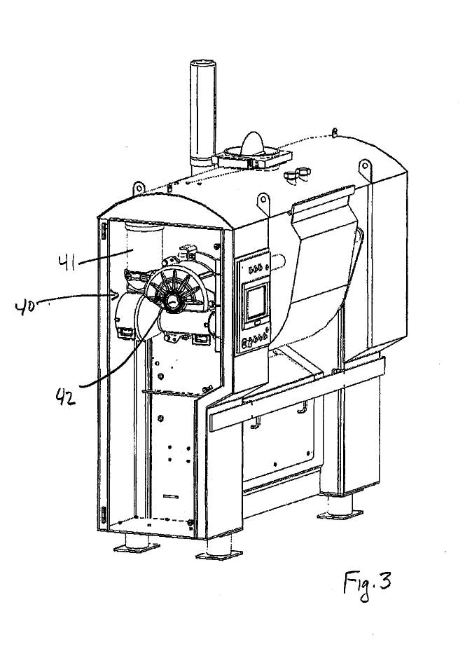

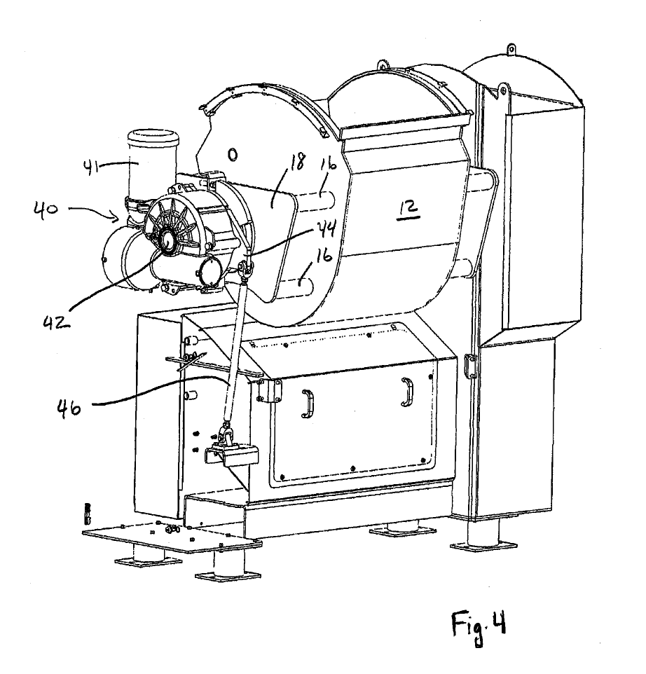

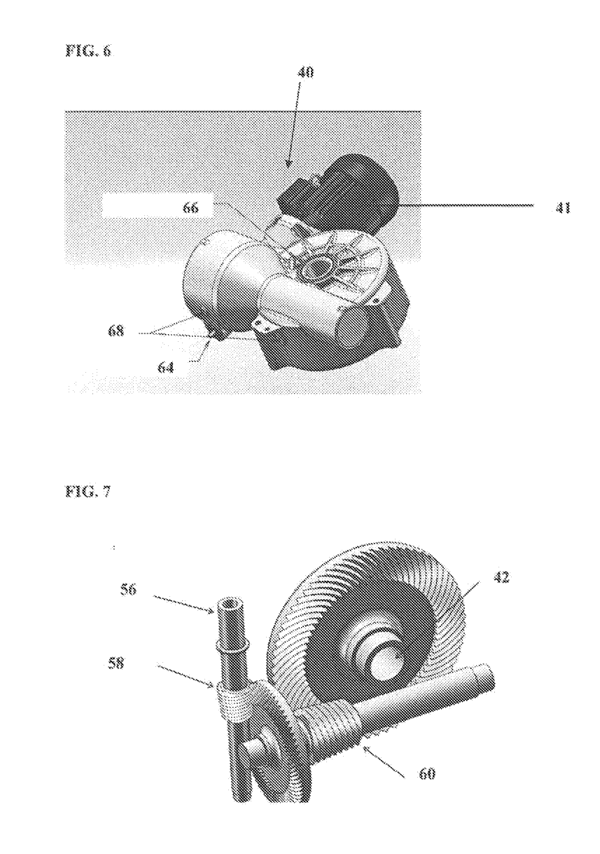

In this regard, and referring to FIGS. 3-6 as well, a multi-reduction gearbox unit 40 is mounted with an output hub 42 connected to a spline shaft 43 (also seen in FIG. 8) associated with and extending from a tilt bearing head portion of the bearing arrangement 30, where rotation of the spline shaft 43 effects rotation of the support plate 18 and thus tilt of the bowl. As best seen in FIG. 6, the gearbox unit 40 may be a self-contained unit, inclusive of the motor 41. In addition to the connection of the hub to the spline shaft, the gearbox unit is mounted to a plate 44 (e.g., by bolts or other fasteners) having an associated torque arm 46 that prevents rotation of the plate 44 and thus also prevents rotation of the gearbox unit 40 itself. The bowl-tilt system includes a rotation limit plate 50 that interacts with upper and lower stops 52, 54 to define the rotational position limits of the plate 18, and thus the bowl. By way of example, the typical limit of rotation may be about one-hundred twenty degrees. However, variations are possible, including a full three-hundred sixty degrees of rotation, and in some embodiments the device could be arranged to rotate the bowl both directions. The downstream end of the spline shaft 43 is connected to the plate 50 (e.g., via a welded connection or any other suitable connection) to effect rotation of the plate, and one or more bolts 51 extend through the plate 50, the exterior portion of the bearing arrangement and the support plate 18 so that rotation of the plate 50 imparts rotation of the support plate 18.

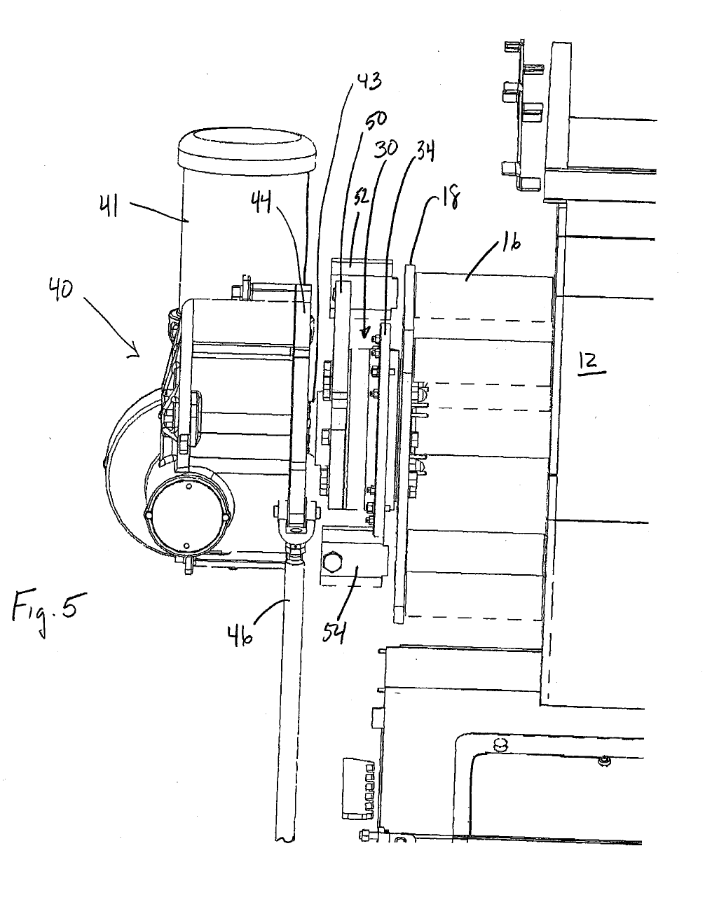

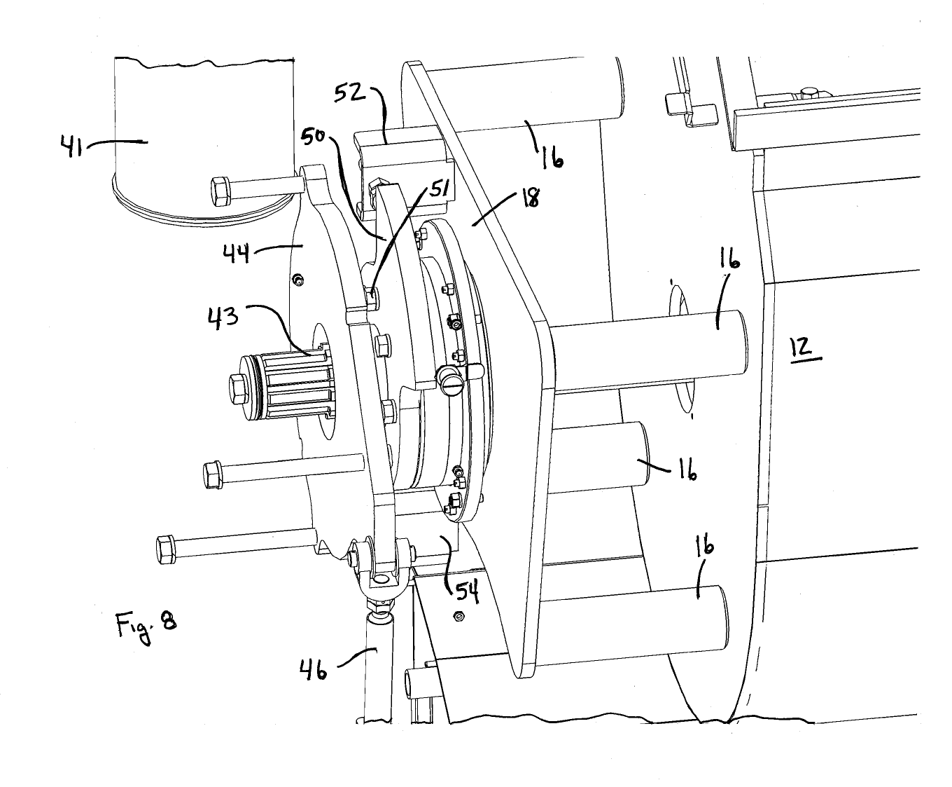

As best seen in FIGS. 5-7, the unit includes a multi stage right angled gearbox with housing, where the housing may be constructed of aluminum. An inverter duty motor 41, via coupling to an end of an input or primary shaft 56, drives a first stage reduction 58 of the gearbox. This power is transmitted at a right angle to another stage of reduction 60 at the output hub 42. The output hub 42 is coupled with the tilt actuation plate 18 using a spline shaft 43 arrangement. The gear train layout is shown in FIG. 7 and, in this embodiment, reflects a skew-axis gearing arrangement (i.e., non-intersection and non-parallel axis gearing). The gears may be configured to withstand high contact stresses during tilt actuation. The gearbox 40 is non-back driving and self locking using a multi stage reduction (i.e., the gearbox 40 will maintain its position under load when motor 41 is not functional). The gearbox 40 is also configured to produce high torque output using large contact surface areas. The gearbox 40 can perform under high moment and impact loading from the mixer's jog and tilt duty cycle. The multi-stage gearbox 40 is robustly configured to run large duty cycles. The multi-stage gearbox 40 can be used for all tilt and over tilt bowl actuations. The design is scalable and the rated output torque from the gearbox can be achieved for mixers based on their load capacities.

By way of example, and as seen in FIG. 7, each of the first stage reduction 58 and second stage reduction 60 of the gearbox 40 include gear mesh of at least 5 gear teeth (e.g., 7 or more gear teeth). In the first stage reduction 58, meshing may occur at between about 8° and 12° (e.g., about10°) inclination of both gears, while in the second stage reduction 60 meshing may occur at above 25° (e.g., between about 25° and 35° , or about30°) inclination of both gears.

The first stage reduction 58 may be on the order of between about 35 and 45 to 1 (e.g., about 40 to 1) and the second stage reduction 60 may be on the order of between about 15 and 30 to 1 (e.g., about 22 to 1), resulting in an overall reduction of between about 525 and 1350 to 1 (e.g, between about 800 and 950 to 1, or about 880 to 1). In an exemplary application with an overall reduction of 880 to 1 and utilizing a 5 hp motor operating at 60 Hz, the torque input of 180 in-lb will be converted to 69,446 in-lb of output torque at the gearbox hub 42. Utilizing an overall reduction in the range of 880 to 1, the drive motor 41 may be operated at an input speed of 1800 rpm to achieve an output gearbox hub 42 speed of about 2 rpm, providing a controlled rotation of the mixer bowl 12. Utilizing the same 5 hp motor operating at 50 Hz, and assuming the same 880 to 1 reduction, the torque input of 210 in-lb will be converted to 81,020 in-lb of output torque at the gearbox hub 42. Operating such a motor at 1500 rpm will result in an output gearbox hub 42 speed of about 1.7 rpm, again providing a controlled rotation of the mixer bowl.

The gearbox unit 40 may provide a manual bypass feature 64 which is located on the bottom of the housing. This manual bypass feature 64 allows for the input shaft 56 (normally driven by the motor 41) to be rotated at its lower end using a hand tool or power assisted tool during power failure or motor failure. The gearbox bearing, seals and gearing are configured to require little or no mechanical service (other than normal changing of gearbox oil). The gearbox unit 40 is equipped with fill, level plug 66 and drains plugs 68, as shown in FIG. 6. Notably, when the gearbox unit is in its installed condition on a mixer, the fill and level plug 66 is located at a height that is higher than the height of both the first stage reduction and second stage reduction. Drain plugs 68 are provided at the bottom of both the portion of the housing associated with the first reduction 58 and the portion of the housing associated with the second reduction 60.

Notably, the gearbox 40 is a direct driven connection to the tilt bearing head and eliminates the need for hydraulics on large dough mixers. Due to the self-contained nature of the gearbox unit 40, it provides installation and parts count reduction on the tilt actuation assembly. The gearbox 40 has a non-back driving and self locking gear design thus increasing functional flexibility. An inverter duty motor 41 may drive the gearbox 40 to produce sufficient torque required to actuate the tilt mechanism of the mixer bowl 12. The manual override feature 64 of the gearbox 40 ensures the bowl can be manually rotated open/closed in the event of a loss of power. The gearbox unit 40 is completely sealed and compact to ensure the gearbox 40 can be added on to existing machines. The gearbox 40 may be CE certified which facilitates sanitary design-wash down duty.

It is to be clearly understood that the above description is intended by way of illustration and example only and is not intended to be taken by way of limitation, and that changes and modifications are possible. For example, the gear ratios, reductions and gear mesh angles mentioned herein are exemplary only. Accordingly, other embodiments are contemplated and modifications and changes could be made without departing from the scope of this application.

What is claimed is

1. A horizontal mixer comprising
a mixer bowl,
an agitator within the mixer bowl,
an agitator shaft for moving the agitator, the agitator shaft extending through a wall of the mixer bowl,
at least one support connected to support the mixer bowl and pivot the mixer bowl;
a bearing assembly comprising a first portion that is rigidly connected for movement with the support and a second portion that rotatably supports the agitator shaft, and
a bowl-tilt mechanism comprising a multi-stage gear reduction unit having an input and an output, where the output is operatively connected to the first portion of the bearing assembly such that rotation of the output effects rotation of the first portion of the bearing assembly to rotate the support and thus the mixing bowl.

2. The mixer of claim 1 wherein the input of the multi-stage gear reduction unit is a shaft that is directly rotated by a motor.

3. The mixer of claim 1 wherein the multi-stage gear reduction unit is rigidly mounted to inhibit rotation of the multi-stage gear reduction unit.

4. The mixer of claim 3 wherein the multi-stage gear reduction unit is mounted to a plate and a torque arm has one end connected to the plate and an opposite end connected to a frame of the mixer.

5. The mixer of claim 1 wherein the multi-stage gear reduction unit is non-back driving and self locking

6. The mixer of claim 1 wherein the multi-stage gear reduction unit has an associated motor to provide a self-contained unit.

7. The mixer of claim 6 wherein the multi-stage gear reduction unit includes a fill level port that is located above a level of both a first stage reduction and a second stage reduction of the unit.

8. The mixer of claim 6 wherein the input is associated with the first stage reduction and is a primary input that is driven by the motor, the multi-stage gear reduction unit further includes a secondary input for enabling operation of the unit via a hand tool or power tool.

9. The mixer of claim 8 wherein the primary input is associated with a first end of a primary shaft of the first stage reduction and the secondary input is associated with a second end of the primary shaft.

10. The mixer of claim 1 wherein the multi-stage gear reduction unit includes a first stage reduction and a second stage reduction, wherein power from the first stage reduction is transmitted at a right angle to the second stage reduction.

11. The mixer of claim 10 wherein the first reduction stage reduction and the second reduction stage reduction are in a skew-axis gearing arrangement.

12. The mixer of claim 1 wherein the multi-stage gear reduction unit includes a first stage reduction and a second stage reduction, the first stage reduction is between about 35 to 1 and about 45 to 1, and the second stage reduction is between about 15 to 1 and about 30 to 1, resulting in an overall reduction of between about 525 to 1 and about 1350 to 1.

13. The mixer of claim 12 wherein the overall reduction is between about 800 to 1 and about 950 to 1.

14. The mixer of claim 1 wherein the bowl-tilt mechanism further comprises a rotation limit plate that interacts with stops to provide rotational position limits of the mixing bowl.

15. The mixer of claim 14 wherein rotation of the mixer bowl is limited to about one-hundred twenty degrees.

16. A mixing bowl-tilt system for a horizontal mixer, comprising
a multi-stage gear reduction unit having an input and an output, wherein the input is connected to be rotated by a motor and the output is operatively connected to rotate a mixing bowl, such that rotation of the input results in rotation of the mixing bowl, and wherein the multi-stage gear reduction unit is non-back driving and self locking and includes a first stage reduction and a second stage reduction.

17. The system of claim 16 wherein the first stage reduction is between about 35 to 1 and about 45 to 1, and the second stage reduction is between about 15 to 1 and about 30 to 1, resulting in an overall reduction of between about 525 to 1 and about 1350 to 1.

18. The system of claim 16 wherein the input is associated with the first stage reduction and is a primary input that is driven by the motor, the multi-stage gear reduction unit further includes a secondary input for enabling operation of the unit via a hand tool or power tool, the primary input is associated with a first end of a primary shaft of the first stage reduction and the secondary input is associated with a second end of the primary shaft.

19. A horizontal mixer comprising
a mixer bowl,
an agitator within the mixer bowl,
an agitator shaft for moving the agitator, the agitator shaft extending through a wall of the mixer bowl,
at least one support connected to support the mixer bowl and pivot the mixer bowl;
a bearing assembly comprising a first portion that is rigidly connected for movement with the support and a second portion that rotatably supports the agitator shaft, and
a bowl-tilt mechanism comprising a gear reduction unit having an input and an output, where the output is operatively connected to the first portion of the bearing assembly such that rotation of the output effects rotation of the first portion of the bearing assembly to rotate the support and thus the mixing bowl.

20. The horizontal mixer of claim 19 wherein:
the reduction effected by the gear reduction unit is between about 525 to 1 and about 1350 to 1; and/or
the gear reduction unit includes at least two stages of reduction.
